(19) United States
(12) Patent Application Publication
(10) Pub. No.: US 2021/0284222 A1
(43) Pub. Date: Sep. 16, 2021

(54) MOTORIZED WHEELBARROW

(71) Applicant: Marko Makarovic, Ljubljana (SI)

(72) Inventor: Marko MAKAROVIC, Ljubljana (SI)

(21) Appl. No.: 17/195,290

(22) Filed: Mar. 8, 2021

(30) Foreign Application Priority Data
Mar. 13, 2020 (SI) P 2020 0 0048

(51) Int. Cl. B62B 5/00; B62B 1/18; B62B 5/04; B62B 5/06

(52) U.S. Cl. CPC B62B 5/0073; B62B 1/18; B62B 5/004; B62B 5/06; B62B 5/0079; B62B 5/04; B62B 5/0053

(57) ABSTRACT

A wheelbarrow with an electric motor built into the wheel helps the user to push and brake the wheelbarrow. A sensor is installed on the handle support, which detects the position of the hand in the axial direction. A button is mounted on the handle support next to the handle. There is an acceleration sensor and a gyroscope on the wheelbarrow. Based on the axial movement of the hand, the wheelbarrow controller calculates the pushing or pulling force of the arms on the handles. The operation of the electric motor is controlled by the wheelbarrow controller via the motor controller, based on the information received from the motor controller, the detected sensor values and the switch status. As a result, the force of the electric motor can be used effectively for an additional drive or braking, so that the required push force of the arms can be reduced. When braking, the motor acts as a generator and charges the battery. Two batteries are placed in the supported legs of the wheelbarrow, which contributes to the weight balance of the wheelbarrow and allows good cooling of the batteries. The construction of the frame provides battery protection and is adapted to transportation on a towing hitch of a passenger car.

### FIELD OF INVENTION

The present invention relates to a wheelbarrow, such as a single-wheeled transport trolley with manual push, and in particular to a wheelbarrow provided with an electric motor having an electric motor to assist in moving the wheelbarrow.

### Technical Problem

A wheelbarrow, such as a hand-pushed single-wheeled transport trolley, is well passable on narrow paths and is often used to transport materials, parts, harvest or fertilizer in workplaces, fields, orchards, mountains or forests. As the wheelbarrow needs to be pushed by hand, manipulating it on poorly maintained paths, meadows or steep slopes is difficult, so the scope of its use is limited. When manipulating the wheelbarrow, it is necessary to push or brake, maintain forward/backward balance and left/right balance. Transporting goods on rough terrain is therefore often difficult, especially for occasional users such as amateur workers maintaining courtyards, houses, gardens and amateur food growers. The need to use a wheelbarrow at a remote location often arises.

### PRIOR ART

These generally known issues give rise to many attempts to develop a convincing product.

Patent WO1992007747A1 proposes a solution to the forward/backward weight balance, in which all drive elements and part of the load space are placed above the wheel axle.

EP0867353A2 proposes an intuitive solution to controlling including a movable handle.

The left/right weight balance is solved by placing the batteries in different positions of the frame.

US2002/0084119A1 solves the weight balance by integrating the motor into the wheelbarrow wheel and the battery under the container.

DE202012009715U1 solves the weight balance by integrating the motor and batteries into the wheelbarrow wheel.

Due to the need for an easy transport of wheelbarrows, wheelbarrows with folding handles are already available on the market.

The solutions proposed so far do not provide an intuitive use comparable to a non-motorized wheelbarrow.

Known solutions to motorised wheelbarrows use a sliding lever or switch to control the drive.

Known battery placement solutions position the battery in a way that the centre of gravity of the battery is above the neutral axis, which raises the total centre of gravity even further from the neutral axis.

### DESCRIPTION OF THE NEW SOLUTION

The invention is based on the background described so far and aims to provide a single-wheel transport trolley with manual push, in which the auxiliary force of the electric motor acts effectively on the wheel to reduce the required force exerted by arms, while reducing battery power consumption and weight balance around the neutral axis is similar to that of a non-motorized wheelbarrow. The wheelbarrow should be intuitively manageable and easy to transport, and its stored energy and unoccupied volume should also be used for other purposes.

In order to achieve the above identified purpose, in accordance with a first aspect of the invention, a wheelbarrow with an electric drive is proposed, which comprises: a frame for a container; a wheel mounted in the middle of the lower part of the frame of the container; right and left handle supports extending backwards from two sides of the frame for the container; a left and right leg, which are an integral part of the frame; an electric motor mounted in said wheel, which drives or brakes the wheelbarrow only when necessary; two separate batteries mounted in a protective housing attached to said legs; two handles overlapping to a limited extent said pair of supports which are fixed with respect to said supports; a contactless sensor for detecting the position of a hand that is attached to one of said handle supports; a multi-axis acceleration sensor rigidly connected to said frame, buttons accessible by a finger while simultaneously holding said handles; and a control system for monitoring the operation of said electric motor based on motor controller information, detected values of sensors for detecting the position of the user's hand, wheelbarrow position, temperature sensors of each battery, and allowing a selection of different operating modes according to the sequence of pressing said button.

According to the construction of this first aspect, the pushing forces acting on the handles are detected via a small movement of the hands in the forward/backward direction. The hand position sensor transmits a signal to the wheelbarrow controller so that the motor can drive the wheelbarrow according to push forces and manual work can be reduced, so a fully loaded wheelbarrow can be pushed onto a rough or gravel surface. With an empty container or in a slightly filled state on a level ground, the energy consumption of the battery can be reduced by not activating the electric motor.

In addition, the wheelbarrow is pushed by lifting the handles and then the pushing force acts on the handles. Especially if the load is transported on rough terrain or a slope, the position of the frame of the container may become unstable. Loss of balance is often further caused by the push of the grip of the handle on one side. Thus, the hand displacement sensor can detect the push forces that need to be applied to the grip in order to apply the correct traction force to the wheel.

The position of compact separate batteries allows for an optimal compromise between left/right and forward/backward balance, greater stability and easier manipulation with the container fully loaded or empty. The choice of modern batteries allows for a suitable compact installation and ensures great autonomy of operation. The battery installation method provides user protection against possible explosion of the battery and at the same time protects the battery from mechanical damage. Placing the battery in the housing, which is an integral part of the legs of the support frame, allows adequate cooling of the batteries and preserves the space under the container for the attachment of other electrical devices.

The use of a suitably large wheel allows the use of standard winter-profile tyres for scooters, which ensures better grip of the drive wheel on slippery surfaces at an acceptable cost, while allowing significantly smoother driving compared to tractor-profile tyres, which is especially noticeable on smooth hard surfaces.

Short overall length of the wheelbarrow and flanges built into the legs of the support frame for attaching the transport support contribute to an easy transport of the wheelbarrow on a towing hitch of a passenger car.

### SHORT DESCRIPTION OF DRAWINGS

FIG. 1 shows a preferred construction of a wheelbarrow with basic structural elements; a wheel with a built-in motor 1; a support frame 2 of the wheelbarrow, two support legs 3 that are an integral part of the support frame 2; plastic handles 4 fixed to the support frame 2; a container 5 for transporting load; a shield 6 of an hand movement sensor; a button 7; a battery housing 8; a control unit housing 9; a cooling part 10 of the engine power controller; a mounting flange 11 of a leg for attaching a support to a towing hitch; a protective tube 12 for conductors connecting the battery and the control unit, which protective tube is rigidly connected to the battery housing 8 and a support 13; a support 13 which rigidly connects the container 5 to the frame 2, and the control unit housing 9 via damping elements 16; a wheel support 14; a tyre 15; an elastic damping element 16; a support 17 that rigidly connects the container 5 to the frame 2; a support 18 that rigidly connects the front portion of the container 5 and the front portion of the frame 2; a battery housing cover 19.

FIG. 2 shows a detailed view of the control part mounting.

FIG. 3 shows a side view showing a neutral axis 20 and the positions of the centre 21 of gravity of batteries and the centre 22 of gravity of the entire wheelbarrow.

FIG. 4 shows a wheelbarrow with designated components of the battery housing 8 and the battery housing cover 19, a tyre 15 with a tread pattern having grooves 23, and the mounting flange 24 of the wheel.

FIG. 5 shows a preferred control diagram of the wheelbarrow drive. The control unit housing 9 accommodates a motor controller, a wheelbarrow controller, an accelerometer and a gyroscope. In the control unit housing 9, conductors from both batteries are connected and supply the motor controller and the wheelbarrow controller. Conductors from a switch, an hand position sensor, which is an ultrasonic sensor, the motor and both batteries are led into the control unit housing 9.

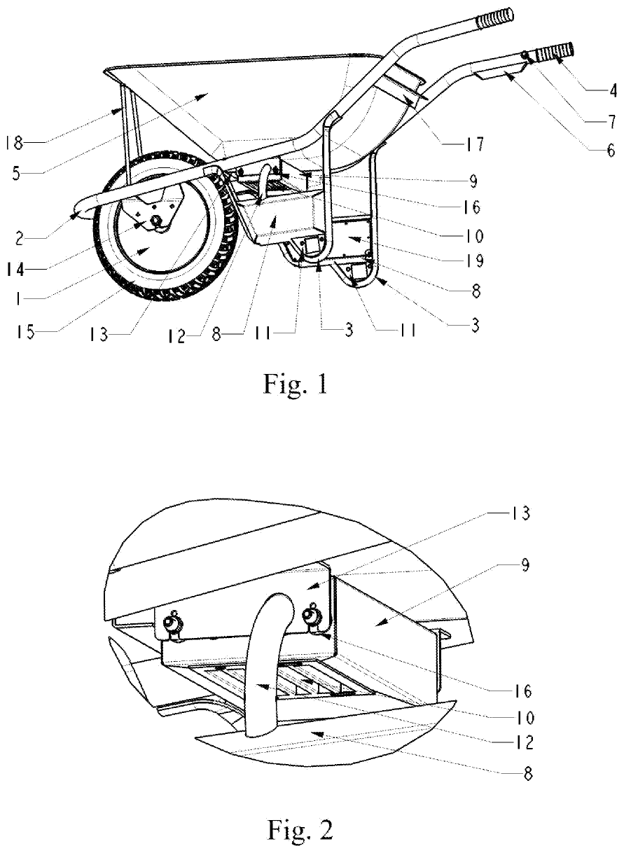

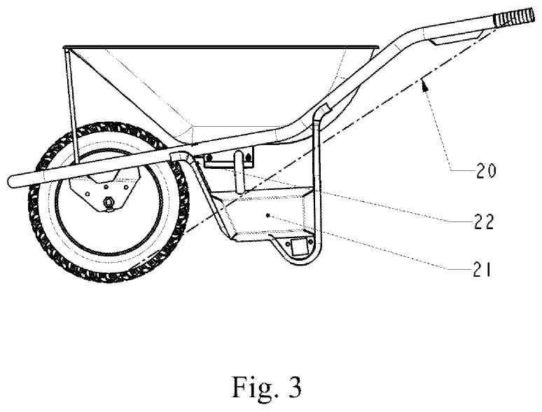

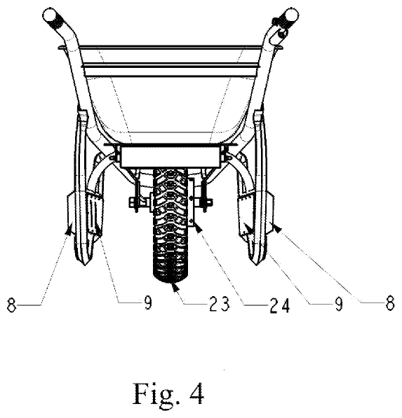

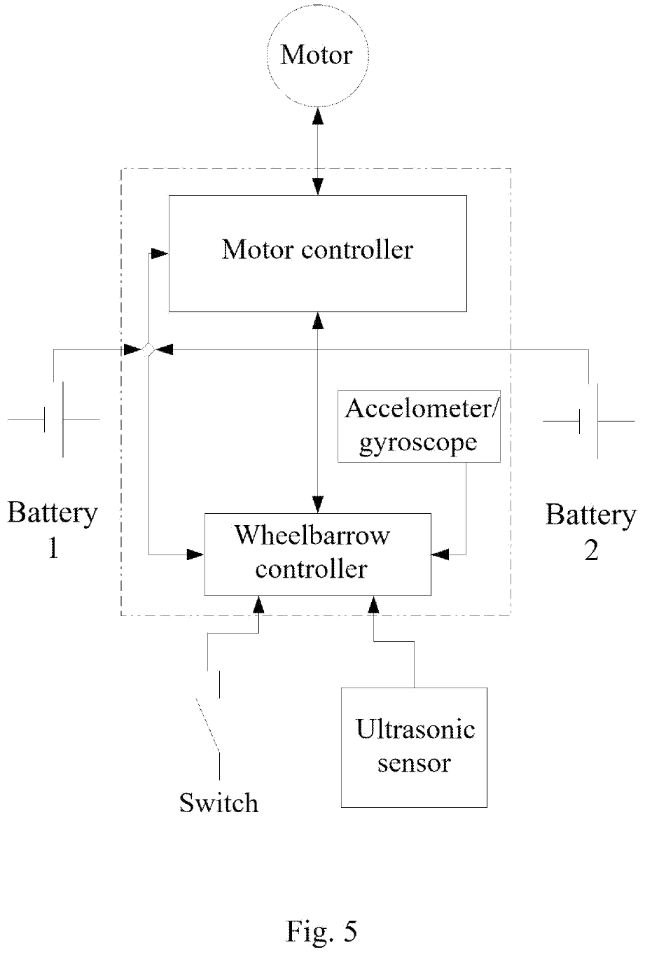

The wheel 1 comprises a wheel rim and a built-in motor, and is attached via a shaft to a wheel support 14 via a preferably form-fit connection. On one side of the motor, there is a mounting position of the wheel, preferably a perforated flange 24 which is preferably rigidly attached to the motor cover. Preferably, the rim is adapted to tubeless tyres having dimensions 3.00-10.

The support frame 2 is preferably made of a steel tube, preferably of round cross-section.

The support legs 3 are preferably made of a curved steel L-profile and are preferably welded to the support frame 2.

The plastic handles 4 are preferably round in shape and preferably glued to the tube of the support frame 2.

The container 5 is preferably made of sheet steel and is preferably welded to the support frame 2 via supports 13 and 17.

The shield 6 of the hand movement sensor is preferably circular in shape and preferably welded to the support frame 2, preferably positioned on the underside.

The button 7 is—preferably via an intermediate flange—preferably welded to the support frame 2, preferably positioned so that its upper edge does not reach the upper point of the support frame 2 at this point in height.

The battery housing 8 is preferably made of sheet steel and is preferably welded to the supported legs 3. It is configured in a way to form, together with the battery housing cover 19, an enclosed space of such a size that it embraces the battery together with the surrounding damping element, which preferably at the same time provides good thermal conductivity.

The control unit housing 9 is preferably made of sheet steel and preferably encloses the power motor controller and the wheelbarrow controller in a watertight manner. The control unit housing 9 is preferably attached to the support 13 via cylindrical damping elements 16 by a screw connection.

The cooling part 10 of the power motor controller has free access to the environmental air so as to provide sufficient cooling.

The two mounting flanges 11 of the supporting legs 13 with a form-fit connection, preferably with a rectangular cut-out, allow for adequate rigidity of the connection with the support for connection to the towing hitch.

The protective tube 12 is preferably made of a curved steel tube and is preferably welded on one side to the battery housing 8 and on the other side to the support 13.

The support 13 is preferably made of sheet steel and is preferably welded to the support frame 2.

The wheel support 14 is preferably made of sheet steel and is preferably welded to the support frame 2.

The tyre 15 is preferably a winter tyre for scooters.

The elastic damping element 16 is preferably fastened by a screw connection to the control unit housing 9 and the support 13, and is dimensioned to prevent the transmission of shocks from the support frame 2 to the control unit housing 9.

The support 17 is preferably made of sheet steel and connects the rear part of the container 5 with the rear part of the support frame 2 preferably via a welded joint.

The support 18 is preferably made of a curved steel bar and connects the front part of the container 5 with the front part of the support frame 2 preferably via a welded joint.

The battery housing cover 19 is preferably made of sheet steel and is preferably fastened to the battery housing 8 with a screw connection.

The neutral axle 20 extends from the grip of the hand with the handle to the junction of the tyre with the ground.

The position of the centre 21 of gravity of the batteries, far below the neutral axis 20, makes it possible to compensate for the unfavourable location of the centre of gravity of the motor and the centre of gravity of the container above the neutral axis.

The goal of balancing the wheelbarrow left/right is to keep the centre 22 of gravity of the wheelbarrow as close to the neutral axis 20 as possible.

The thread pattern of the tyre includes a number of grooves 23 mimicking winter tyres.

The mounting position of the wheel Tallows the connection of various devices, preferably a flange of a towing winch.

The motor is preferably a brushless DC motor and preferably transmits torque directly to the wheel shaft. The motor controller is preferably a controller used to control electric scooters. The wheelbarrow controller is preferably based on a 32-bit microcontroller and preferably has a built-in voltage converter to supply power from a preferably 48 V battery. The wheelbarrow controller receives signals from the sensors and the motor controller. The hand position sensor detects the position of the user's hand and transmits information to the wheelbarrow controller. The hand position sensor is mounted in the shield 6 of the sensor via a damping element 16. The button 7 is preferably a push-button switch 7 and is connected via conductors, which are disposed preferably in a tube of a support frame, to the wheelbarrow controller. The wheelbarrow controller changes the operating mode and emergency stop preferably based on different sequences of button pushes. Based on the axial movement of the arm, the wheelbarrow controller calculates the pushing or pulling force of the arms on the handles. The wheelbarrow controller controls the motor controller preferably via a software-implemented PID control mode. The batteries are preferably formed of lithium cells and preferably have a built-in monitoring system. The batteries preferably include a temperature sensor and provide temperature-related information to the wheelbarrow controller. The accelerometer preferably transmits acceleration data in three directions to the wheelbarrow controller. The gyroscope preferably transmits data on rotation about three axes to the wheelbarrow controller.

1. An electric motor driven wheelbarrow comprising:
a frame for a container;
a wheel mounted in the middle of the lower part of the frame of the container;
a pair of right and left handle supports extending backwards from two sides of the frame for the container;
a pair of left and right legs, which are an integral part of the frame;
an electric motor mounted in said wheel, which drives or brakes the wheelbarrow only when necessary;
two separate batteries mounted in a protective housing attached to said legs;
two handles overlapping to a limited extent said pair of supports which are fixed with respect to said supports;
a contactless sensor for detecting the position of a hand that is attached to one of said handle supports;
a multi-axis acceleration sensor rigidly connected to said frame,
buttons accessible by a finger while simultaneously holding said handles;
and
a control system for monitoring the operation of said electric motor based on motor controller information, detected values of sensors for detecting the position of the user's hand, wheelbarrow position, and allowing a selection of different operating modes according to the sequence of pressing said key.

2. A wheelbarrow according to claim 1, the control system of which provides feedback on the selected mode of operation via different sequences of wheel movement forwards and backwards.

3. A wheelbarrow according to claim 1, the control system of which enables, based on the data from the sensors, the detection of the cadence of steps and adjusts the power of the drive within the step accordingly.

4. A wheelbarrow according to claim 3, the control system of which enables the detection of inequalities between the left and right steps and adjusts the power of the drive accordingly, depending on the left and right steps.

5. A wheelbarrow according to claim 1, the control system of which makes it possible to detect wheel slip, preferably by comparing the acceleration of the wheel with the acceleration of the wheelbarrow, on the basis of which it reduces the motor torque if necessary.

6. A wheelbarrow according to claim 1, the control system of which enables redundant control, wherein in the event that the system detects an illogicality on one input signal compared to at least two other input signals, it is automatically switched to standby mode.

7. A wheelbarrow according to claim 1, the control system of which enables communication, preferably wireless communication with other devices.

8. A wheelbarrow according to claim 1, the batteries of which are arranged in a way that their centre of gravity is below the axis connecting the point of grip of the hands with the point of contact of the wheel with the ground, preferably as low as possible.

9. A wheelbarrow according to claim 1, comprising a fastening system for fastening to a towing hitch, preferably with an attachment which allows easy fastening and removal of the fastening system which can remain attached to the towing hitch.

10. A wheelbarrow according to claim 9, comprising an electrical plug on the connecting electrical cable for charging the wheelbarrow batteries from a trailer via a type socket.

11. A wheelbarrow according to claim 1, the controller housing of which is designed to simultaneously form a speaker housing for sound reproduction.

12. A wheelbarrow according to claim 1, having attachment points, preferably on the container frame, which make it possible to attach an external speaker, preferably an active one, to the container, and preferably to supply it with the batteries of the wheelbarrow.

13. A wheelbarrow according to claim 1, which has a standard 12V car socket built into the controller housing.

14. A wheelbarrow according to claim 1, which has a built-in standard car 12V plug with an extension, which allows charging in 12V car sockets via a built-in voltage level converter.

15. A wheelbarrow according to claim 14, having a spiral extension cable, preferably exceeding 1 m and stored in the frame during non-use.

16. A wheelbarrow according to claim 1, wherein the tyre profile consists of a number of lamellae, preferably identical to the profile of winter tyres for motor cycles.
